(19) United States
(12) Patent Application Publication
(10) Pub. No.: US 2009/0297897 A1
(43) Pub. Date: Dec. 3, 2009

(54) METHODS FOR MONITORING HYDROGEN FUELING SYSTEMS

(76) Inventors: Robert Walter BOYD, Orinda, CA (US); Michael CIOTTI, Nazareth, PA (US); Michael MCGOWAN, Valley Cottage, NY (US)

Correspondence Address: The BOC Group, Inc., 575 MOUNTAIN AVENUE, MURRAY HILL, NJ, 07974-2082, US

(21) Appl. No.: 12/329,201

(22) Filed: Dec. 5, 2008

Related U.S. Application Data
(60) Provisional application No. 61/012,121, filed on Dec. 7, 2007.

(51) Int. Cl. H01M 8/04; G01M 3/04

(52) U.S. Cl. 429/17; 73/40

(57) ABSTRACT

The present invention provides a process and apparatus for monitoring and inhibiting leaks from a hydrogen gas fueling system. A fueling event controller measures the pressure of the hydrogen gas before, during and after a fueling operation and if certain pressure values are exceeded, can shut down the hydrogen gas fueling system.

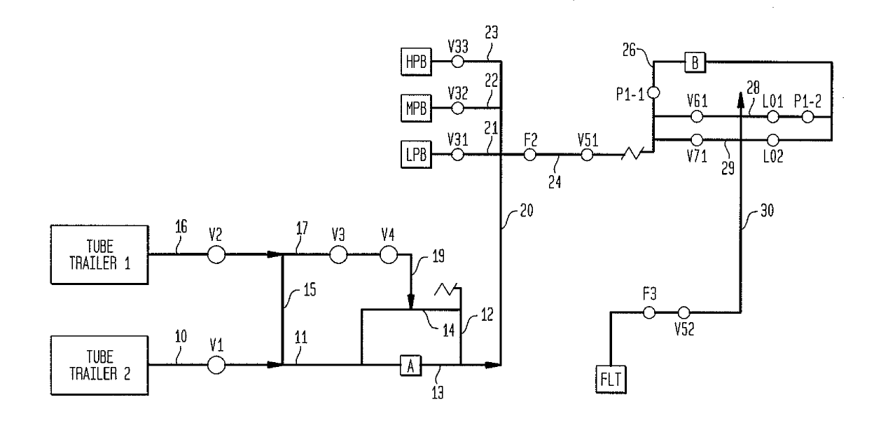

### CROSS REFERENCE TO RELATED APPLICATIONS

This application claims priority from U.S. Patent Application Ser. No. 61/012,121 filed Dec. 7, 2007.

### BACKGROUND OF THE INVENTION

The present invention provides for a process for inhibiting leaks of hydrogen gas from an indoor hydrogen gas fueling system comprising monitoring the pressure of the hydrogen gas in a line leading to a hydrogen gas dispenser.

The present invention further provides for a process for inhibiting leaks of hydrogen gas from an indoor hydrogen fueling system comprising monitoring the pressure of the hydrogen gas in a line leading to a hydrogen gas dispenser during the dispensing of the hydrogen gas and during periods of inactivity.

When hydrogen is produced or purified from a pipeline supply, and delivered locally to support the fueling of hydrogen powered vehicles, a compressor must be sized to accommodate the mass flow and discharge pressure of the hydrogen generator, purifier or local source, at some multiple of the average hydrogen vehicle demand. Known systems, use one multi-stage compressor to take on-site hydrogen from the output pressure of the generator to the cascading storage pressures required of the vehicle dispensing system. However, for hydrogen vehicle refueling to be entirely useful on a larger, commercial scale, locally produced or purified hydrogen fuel must be manufactured at or near the maximum capacity of the production system, stored in sufficient quantities, and then delivered to the point of use (the vehicle dispenser) efficiently, and promptly, at a mass flow rate of from about 20 to about 100 grams per second.

Known systems use a compressor to facilitate hydrogen fuel manufacture and delivery to the system and an end use at a fixed production rate and capacity that is not dependent on, or even related to the demands and requirements of the selected end use (e.g. capacity and flow rate, etc.). Earlier dispenser systems have required that live hydrogen lines be supplied from the outdoor storage system to the indoor fueling dispenser station. The indoor dispenser then has active valves and flow control devices that could develop hydrogen leaks that may be invisible to a master control system. As such, these leaks are not accounted for and can provide not only for an inefficient fueling system but also a safety hazard. These potential leaks are dealt with by providing gas detection systems inside the building, flame detection systems in the area of the dispenser and general, system wide forced ventilation systems.

Although necessary, these risk mitigation devices or systems will require the expenditure of money in terms of capital cost, installation cost, maintenance cost and operations cost. The present invention provides for a system where the problems of leaks are addressed by moving the hydrogen dispenser control and hydrogen isolation valves outside of the indoor fueling dispenser station and the single hydrogen pipe for each indoor dispenser is continuously monitored for leaks.

### SUMMARY OF THE INVENTION

In one embodiment of the present invention, there is disclosed a method of monitoring a hydrogen fueling system for leaks comprising:

Feeding hydrogen to said system through a pressure regulating device;

Feeding said hydrogen through a first pressure check system and a second pressure check system; wherein said first and said second pressure check systems are in fluid communication with a fueling event controller;

Measuring the pressure of said hydrogen through said first and said second pressure check systems; and

Stopping the flow of hydrogen through said pressure regulating device in the event that the pressure as measured by either of said first pressure check system or said second pressure check system deviates by a predetermined amount from a standardized pressure.

In another embodiment of the present invention, there is disclosed a method for monitoring the fueling of a hydrogen-powered vehicle comprising:

Feeding hydrogen to said hydrogen-powered vehicle through a pressure regulating device;

Feeding said hydrogen through a first pressure check system and a second pressure check system; wherein said first and said second pressure check systems are in fluid communication with a fueling event controller;

Measuring the pressure of said hydrogen through said first and said second pressure check systems; and

Stopping the flow of hydrogen through said pressure regulating device in the event that the pressure as measured by either of said first pressure check system or said second pressure check system deviates by a predetermined amount from a standardized pressure.

The hydrogen fueling system can be employed to fuel any hydrogen-powered vehicles, particularly but not limited to fork lift trucks. The methods of the present invention are useful in hydrogen filling systems that operate at pressures up to 250 bar.

The methods of the present invention provide monitoring of a hydrogen fueling system during both the actual filling of a hydrogen-powered vehicle but also during times when the fueling system is waiting to be employed. During the filling of the hydrogen-powered vehicle, the methods of the present invention will operate during both full load fueling of hydrogen and compensated or partial fills of hydrogen gas.

A fueling event controller will monitor the pressure of the hydrogen gas present in the fueling system both during the fueling operation and periods where the system is idle. If a certain pressure change event occurs, the PLC equipped fueling event controller will signal various valves and shut the system down. This will inhibit potential damage caused by leaks and the remediation efforts needed to address them.

The present invention further relates to an apparatus for monitoring for leaks of hydrogen gas from an indoor hydrogen gas fueling system comprising a hydrogen supply line, a hydrogen gas pressure monitor and a hydrogen dispensing system.

### BRIEF DESCRIPTION OF THE DRAWINGS

The FIGURE is a schematic of a 250 bar hydrogen fork lift truck fueling system.

### DETAILED DESCRIPTION OF THE INVENTION

The FIGURE is a schematic representation of a 250 bar hydrogen fork lift truck fueling operation. Hydrogen gas is fed from two tube trailers at different pressures which can be controlled through a series of valves prior to the gas being directed to a compressor system. The hydrogen gas from the tube trailers may also be fed directly to a line leading to a series of storage banks. The gas which is either compressed by the compressor system or directly fed from the tube trailers is directed to the three storage banks. These banks can be used during operation of the hydrogen gas filling system as the primary source of hydrogen. The hydrogen gas may also come directly through to the fuelling system from the tube trailers.

The hydrogen gas whether it is directly fed from the tube trailers or from the three pressure banks passes through a filter, Filter-2 and valve system V-51. The filters will limit particulates from entering control valves and the vehicle. The hydrogen gas will be directed through a valve assembly at 250 bar and metered at 60 grams/sec maximum to a second valve V-52 and through another filter Filter 3 before being dispensed into the hydrogen powered fork lift truck. Should the pressure of the hydrogen gas be 50 bar, then the flow rate is set to 30 gram/sec maximum. The line connecting to the hydrogen powered fork lift truck is designed to break away at the sealing should an emergent situation occur.

In operation the hydrogen source can be from a tube trailer designated GH1 Tube Trailer 1 and GH2 Tube Trailer 2. Alternatively the hydrogen source can be from a storage tank. In this instance the three storage tanks labeled LPB, MPB and HPB are designed to deliver the hydrogen to the hydrogen powered vehicle at different pressures.

When the source of hydrogen is from GH2 Tube Trailer 1, the hydrogen flows through line 10 to valve V1 where the pressure of the hydrogen can be adjusted. The hydrogen flows through line 11 and into compressor A where the pressure of the hydrogen is increased. The higher pressure hydrogen leaves the compressor though line 13 where it is directed through line 12 to a vacuum release device. The hydrogen also travels through line 20 to a filter F2 where impurities are removed and this purified hydrogen is passed through valve V51. V51 is in electronic communication with the fueling event controller and can be shut off should the signal received by the fueling event controller B exceed a particular preset value.

The hydrogen travels through line 26 and in the event of compensated fueling will travel through line 28 and valve V53 where its pressure is increased. The hydrogen will pass through LO1 which is a limiting orifice and can be set for a hydrogen flow rate of 60 gram/second at 250 bar hydrogen pressure. This hydrogen then travels through valve V52 and filter 3 before being directed into the hydrogen-powered vehicle FLT. Line 30 connects to a sealing breakaway which is not shown which can become disconnected should there be a problem will the fueling of the hydrogen-powered vehicle such as improper operator filling technique. Valves V52 and V53 are also in electronic communication with the fueling event controller B and can be shut off completely should the fueling event controller receive an electronic signal in excess of a particular preset value.

The hydrogen source may also be from GH2 Tube Trailer 1 where it traverses line 16 to valve V2 and into line 15 and through valves V3 and V4. The hydrogen is directed through line 19 and 14 to line 12 and can be directed into line 20 for passage through the filter F2.

Alternatively the hydrogen source can be from storage tanks. In the FIGURE, HPB, MPB and LPB are the designations for three tanks of hydrogen which are stored at different pressures decreasing in order respectively. The temperatures at these three storage tanks can range from about −20° C. to about 45° C. The hydrogen can be released from any or all of these three tanks and is directed through either of valves V31, V32 or V33 through lines 21, 22 and 23 respectively. The hydrogen so delivered will travel to line 24 where it will pass through filter F2 and valve V51. Depending upon whether the hydrogen-powered vehicle to be fueled is either a compensated fueling or a complete fueling will dictate where the hydrogen travels.

If the vehicle to be filled is waiting on a full fuel load of hydrogen, the hydrogen from valve V51 will travel through line 26 to valve V61. The hydrogen will be increased to 250 bar through valve V61 and be directed through LO1 which is a limiting orifice and the flow rate of hydrogen can be set at up to 30 gram/second at 50 bar with a maximum pressure of 350 bar. The hydrogen leaving LO1 passes through line 30 to valve V52 and through filter F3 for delivery into the hydrogen-powered vehicle. The temperatures of the hydrogen at the vehicle range from about −40° C. to about 90° C.

If the vehicle to be filled is only receiving a partial delivery of hydrogen then the hydrogen will pass through line 26 and valve V53 where it will traverse to line 30 and through valve V52 and filter F3 into the hydrogen-powered vehicle. The valve V53 will allow for an increase in hydrogen pressure of up to 312 bar at 80° C.

The fueling event controller B is in electronic communication with valves V51, V52 and V53. The fueling event controller B can be a programmable logic controller (PLC) such as a computer and communicates through PI-1 and PI-2 where it will receive signals of the hydrogen pressure throughout the hydrogen fill assembly. PI-1 and PI-2 are pressure indicators, typically pressure transducers. Should the pressure of the hydrogen measured at PI-1 or PI-2 differ by a preprogrammed amount from an established programmed norm, then the fueling event controller B will send a signal which will cause any of valves V51, V52 or V53 to close thereby stopping the flow of hydrogen and any leak that may be causing the pressure differential.

The fueling event controller will continuously monitor the hydrogen fueling system to determine if leaks are present during, before and after fueling events occur. During the period between fueling events, the pressure of the hydrogen gas will be monitored such that a low pressure reading of less than about 100 psig and not followed by a fueling event within 60 seconds will result in an ESD (Emergency Shut Down) alarm and system shut down. This monitoring will have the advantage of addressing abnormal conditions where an operator may make improper connections to the fork lift truck and the event of fueling an empty fork lift truck.

During fueling events, the initial system check will see a pressure rise determined by a 2 second pulse and pressure hold for 5 seconds. Any loss of pressure greater than about 100 psig during the system check will result in ESD and a system shut down. Further during the active phase of fueling, any decreasing pressure sensed greater than about 100 psig over a 1 second period will result ESD and system shut down.

While this invention has been described with respect to particular embodiments thereof it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method of monitoring a hydrogen fueling system for leaks comprising:
a) Feeding hydrogen to said system through a pressure regulating device;
b) Feeding said hydrogen through a first pressure check system and a second pressure check system; wherein said first and said second pressure check systems are in fluid communication with a fueling event controller;
c) Measuring the pressure of said hydrogen through said first and said second pressure check systems; and
d) Stopping the flow of hydrogen through said pressure regulating device in the event that the pressure as measured by either of said first pressure check system or said second pressure check system deviates by a predetermined amount from a standardized pressure.

2. The method as claimed in claim 1 wherein said hydrogen fueling system is for fueling of hydrogen-powered vehicles.

3. The method as claimed in claim 2 wherein said hydrogen-powered vehicles are fork lift trucks.

4. The method as claimed in claim 1 wherein said hydrogen is at a pressure of up to 250 bar.

5. The method as claimed in claim 1 wherein said pressure regulating device is a compressor.

6. The method as claimed in claim 1 wherein said first and second pressure check systems are valves.

7. The method as claimed in claim 1 wherein said fueling event controller is a programmable logic controller.

8. The method as claimed in claim 1 wherein said fueling event controller continuously monitors said hydrogen fueling system.

9. The method as claimed in claim 1 wherein said hydrogen fueling system is capable of compensated fueling and full load fueling.

10. The method as claimed in claim 1 wherein a pressure decrease of about 100 psig will stop the flow of hydrogen.

11. A method for monitoring the fueling of a hydrogen-powered vehicle comprising:
a) Feeding hydrogen to said hydrogen-powered vehicle through a pressure regulating device;
b) Feeding said hydrogen through a first pressure check system and a second pressure check system; wherein said first and said second pressure check systems are in fluid communication with a fueling event controller;
c) Measuring the pressure of said hydrogen through said first and said second pressure check systems; and
d) Stopping the flow of hydrogen through said pressure regulating device in the event that the pressure as measured by either of said first pressure check system or said second pressure check system deviates by a predetermined amount from a standardized pressure.

12. The method as claimed in claim 11 wherein said hydrogen fueling system is for fueling of hydrogen-powered vehicles.

13. The method as claimed in claim 12 wherein said hydrogen-powered vehicles are fork lift trucks.

14. The method as claimed in claim 11 wherein said hydrogen is at a pressure of up to 250 bar.

15. The method as claimed in claim 11 wherein said pressure regulating device is a compressor.

16. The method as claimed in claim 11 wherein said first and second pressure check systems are valves.

17. The method as claimed in claim 11 wherein said fueling event controller is a programmable logic controller.

18. The method as claimed in claim 11 wherein said fueling event controller continuously monitors said hydrogen fueling system.

19. The method as claimed in claim 11 wherein said hydrogen fueling system is capable of compensated fueling and full load fueling.

20. The method as claimed in claim 11 wherein a pressure decrease of about 100 psig will stop the flow of hydrogen.
